(19) United States
(12) Patent Application Publication
(10) Pub. No.: US 2019/0339051 A1
(43) Pub. Date: Nov. 7, 2019

(54) CUTTING GUIDE FOR A CUTTING DEVICE AND METHOD OF ASSEMBLING AND OPERATING SAME

(71) Applicant: Gregory Frank Echols, Gainesville, GA (US)

(72) Inventor: Gregory Frank Echols, Gainesville, GA (US)

(21) Appl. No.: 16/403,330

(22) Filed: May 3, 2019

Related U.S. Application Data
(60) Provisional application No. 62/666,206, filed on May 3, 2018.

(51) Int. Cl. G01B 3/10; G01B 5/02; B26D 7/00

(52) U.S. Cl. CPC G01B 3/1084; G01B 2003/1089; B26D 7/0006; G01B 5/02

(57) ABSTRACT

A cutting guide includes a customized measuring tape and adjustable measurement guide. The customized measuring tape is calibrated to account for a typical default displacement from an edge of the cutting guide to a blade of a cutting device positioned next to the edge of the cutting guide. As the distance between the cutting blade and the edge of the cutting guide varies between different cutting devices, the measurement dial is adjustable to account for a difference between the default distance and a particular distance between a particular cutting blade of a particular cutting device and the edge of the cutting guide.

### TECHNICAL FIELD

The present invention relates to a cutting guide for a cutting device.

### BACKGROUND

Traditionally, materials such as wood are cut by using a tape measure to measure a length from an edge of the material to be cut to a point at which a cut is desired, marking a line on the material that intersects the point, and then lining up a cutting device, such as a wood saw, along the line to make the cut.

Unfortunately, this traditional cutting technique is not accurate. Also, the steps required for marking the point, marking the line, and then lining up the cutting instrument to make the cut make this technique unduly cumbersome.

### SUMMARY

According to illustrative embodiments, a cutting guide includes a customized measuring tape and adjustable measurement guide. The customized measuring tape is calibrated to account for a typical default displacement from an edge of the cutting guide to a blade of a cutting device positioned next to the edge of the cutting guide. As the distance between the cutting blade and the edge of the cutting guide varies between different cutting devices, the measurement dial is adjustable to account for a difference between the default distance and a particular distance between a particular cutting blade of a particular cutting device and the edge of the cutting guide.

### BRIEF DESCRIPTION OF SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s) in which:

FIGS. 1 and 2 depict perspective views of a cutting guide for a cutting device, according to an illustrative embodiment.

FIG. 3 depicts a bottom view of a cutting guide for a cutting device, according to an illustrative embodiment.

FIG. 4 depicts a method for assembling a cutting guide according to an illustrative embodiment.

FIG. 5 depicts a method for operating a cutting guide according to an illustrative embodiment.

FIGS. 6A, 6B, and 6C depict a side view, a top view, a front view, and a top view, respectively, of a cutting guide according to an illustrative embodiment.

### DETAILED DESCRIPTION

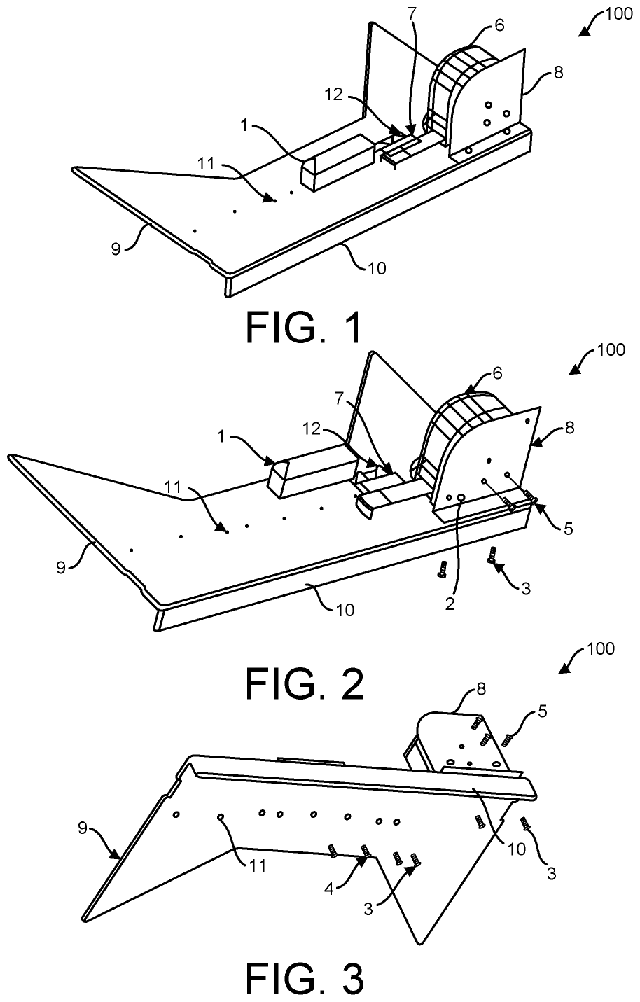

FIGS. 1-3 depict a cutting guide 100 for a cutting device according to an illustrative embodiment. As can be seen from these figures, the cutting guide 100 includes a custom measuring tape 6 mounted on a tape measure mount 8 that is secured to a slide base 9. The custom measuring tape 6 may be attached to the tape measure mount 8 using securing devices, such as button head screws 5 and one or more lock nuts 2. The tape measure mount 8 may be mounted on the slide base 9 using securing devices, such as flat head screws 3 and 4 that can be inserted into apertures or 11 holes from the bottom of the slide base 9.

A measurement dial 7 including a graticule may be arranged next to the measuring tape and opposite the edge of the cutting device. The measurement dial 7 may be secured to the slide base 9 using one or more securing device, such as threaded lock nuts 12, allowing for adjustment of the measurement dial 7 with respect to the custom measuring tape 6. The slide base 9 includes a lip 10 that can be pushed up against material to be cut, e.g., a piece of wood, so that the slide 9 base lies square against the material to be cut.

Although lock nuts, button head screws, and flat head screws have been described as securing devices, it should be appreciated that any other suitable securing devices may be used.

The cutting guide 100 shown in FIGS. 1-3 is intended for use by a right-handed person using the hand grip 1. As shown in FIG. 2, there may be extra holes 11 in the slide base 9, to allow for conversion of the cutting guide to accommodate left hand use.

In the views depicted in FIGS. 1-3, the custom measuring tape 6 is “custom” in the sense that it is calibrated to account for the typical displacement from the right edge of the slide base 9 to the blade of a cutting device (not shown) positioned next to the right edge of the slide base 9. This typical displacement is referred to as a “default” displacement.

The distance between the edge of the slide base 9 to the cutting blade may vary among different cutting devices, e.g., cutting devices made by different manufacturers, due to varying distances between the cutting blade and edge of the different cutting devices. Accordingly, the measurement dial 7 including a graticule may be further adjusted, e.g., moved left or right, to accommodate for different cutting devices.

In operation, the cutting guide 100 shown in FIGS. 1-3 is used in a cutting process by extending an end of the measuring tape 6 out from the measuring tape mount 8 to an edge of the material to be cut and pulling the slide base 9, with the custom measuring tape 6 mounted thereon, across the top surface of the material to a point such that the graticule on the measurement dial 7 is lined up with the desired distance shown on the custom measuring tape 6 at which the cut is desired. Then, the cutting blade of the cutting device is squared up against an edge of the slide base 9 that is opposite the edge of the material to be cut, and the cut is executed.

The cutting guide described herein is easier to use in comparison to the traditional cutting guide described above. Also, the adjustment of the graticule allows for a more accurate cut. For best results, the graticule should be adjusted/calibrated before use with a specific cutting device to account for the distance between the cutting blade and the edge of the cutting guide for that specific cutting device.

Although the example above is described as a straight cut, i.e., it should be appreciated that the cutting guide may also be used for accurate cuts at different angles, e.g., 45°, 30°, etc. Also, the example described above mentions cutting wood with a wood saw, it should be appreciated that the cutting guide may be used with any cutting device to cut any material.

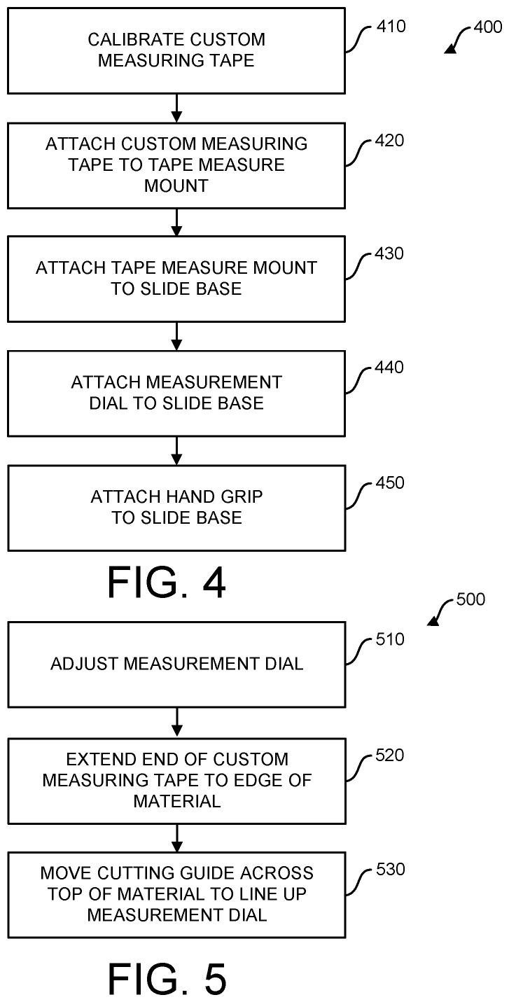

FIG. 4 depicts a method for assembling a cutting guide according to an illustrative embodiment. As shown in FIG. 4, the method 400 includes calibrating a custom measuring tape at step 410. The custom measuring tape is calibrated to account for a default distance from an edge of the cutting guide to a cutting blade of a cutting device to be positioned next to the edge of the cutting guide.

At step 420, the custom measuring tape is attached to a tape measure mount using, for example, button head screws. At step 430, the tape measure mount is attached to a slide base using, for example, flat head screws. At step 440, an adjustable measurement dial is attached to the slide base using, for example, lock nuts. At step 450, a hand grip is attached to the slide base using, for example, flat head screws.

It should be appreciated that the order of the steps shown in FIG. 4 is provided by way of example, and the steps may be performed in any suitable order.

FIG. 5 depicts a method for operating a cutting guide according to an illustrative embodiment. The method 500 includes adjusting a measurement dial mounted to the cutting guide at step 510. The measurement dial is adjusted to account for a difference between a default distance from an edge of the cutting guide to a blade of a cutting device positioned next to the edge of the cutting guide and a particular distance between a particular cutting blade of a particular cutting device and the edge of the cutting guide.

At step 520, an end of a measuring tape mounted to the cutting guide is extended to an edge of material to be cut. At step 530, the cutting guide, with the measurement dial and the measuring tape mounted thereon, is moved across a top surface of the material to be cut to a point such that the graticule on the measurement dial is lined up with a desired distance shown on the measuring tape at which the cut is to be made.

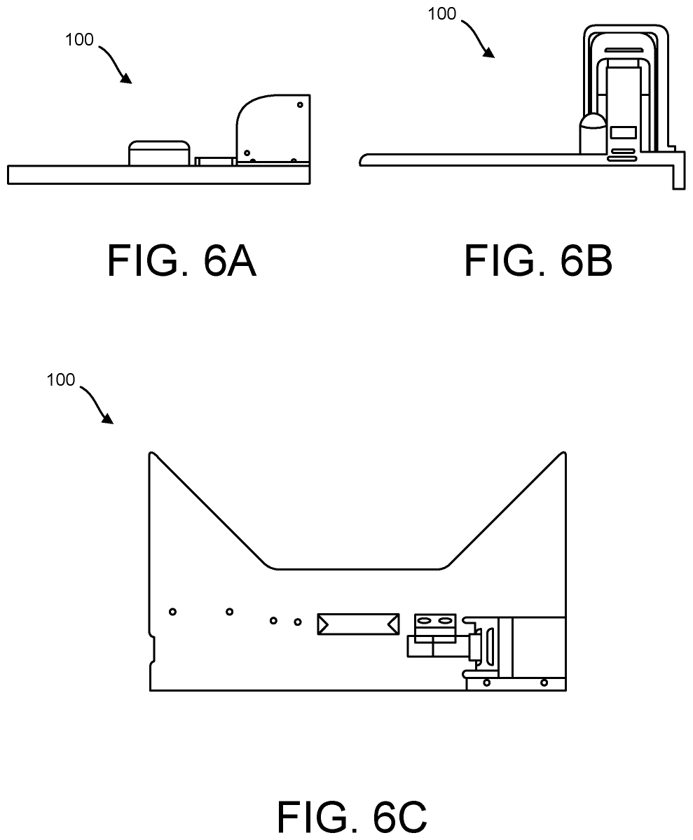

FIGS. 6A-6C depict a side, front, and top view, respectively, of a cutting guide according to an illustrative embodiment. The views depicted in FIGS. 6A-6C also include examples of dimensions of components of the cutting guide. It should be appreciated that these dimensions are provided as one example, and that the dimensions of the cutting guide may be adjusted as desired. Also, only foot-print dimensions are given, as custom component placement is determined by placement of the mounting holes depicted in FIGS. 1-3.

While the various embodiments have been shown and described in example forms, it will be apparent to those skilled in the art that many modifications, additions, and deletions can be made therein without departing from the spirit and scope of the invention as defined by the following claims.

What is claimed is:

1. A cutting guide, comprising:
a measuring tape that is calibrated to account for a default displacement from an edge of the cutting guide to a blade of a cutting device positioned next to the edge of the cutting guide, wherein a distance between the cutting blade and an edge of the cutting guide varies between different cutting devices; and
a measurement dial arranged next to the measuring tape and opposite the edge of the cutting device, wherein the measurement dial is adjustable to account for a difference between the default distance and a particular distance between a particular cutting blade of a particular cutting device and the edge of the cutting guide.

2. The cutting guide of claim 1, further comprising a measuring tape mount on which the measuring tape is mounted.

3. The cutting guide of claim 2, further comprising a slide base to which the measuring tape mount and the measurement dial are secured.

4. The cutting guide of claim 3, wherein the slide base includes a lip to be pushed up against material to be cut so that the slide base lies square against the material to be cut.

5. The cutting guide of claim 3, further comprising a hand grip secured to the slide base.

6. The cutting guide of claim 3, wherein the slide base includes apertures to receive securing devices to secure the measuring tape mount, the measurement dial, and the hand grip.

7. The cutting device of claim 6, wherein the apertures included in the slide base allow the hand grip, the measurement dial, and the measurement tape mount to be secured to the slide base to accommodate right-hand use or left-hand use.

8. The cutting guide of claim 1, wherein the measurement dial includes a graticule.

9. A method for operating a cutting guide, comprising:
adjusting a measurement dial mounted to the cutting guide to account for a difference between a default distance from an edge of the cutting guide to a blade of a cutting device positioned next to the edge of the cutting guide and a particular distance between a particular cutting blade of a particular cutting device and the edge of the cutting guide, wherein a distance between the cutting blade and the edge of the cutting guide varies between different cutting devices; and
extending an end of a measuring tape mounted to the cutting guide to an edge of material to be cut, wherein the measuring tape is calibrated to account for the default distance.

10. The method of claim 9, wherein the measurement dial includes a graticule.

11. The method of claim 10, further comprising moving the cutting guide, with the measurement dial and the measuring tape mounted, across a top surface of the material to be cut to a point such that the graticule on the measurement dial is lined up with a desired distance shown on the measuring tape at which the cut is to be made.

12. The method of claim 11, further comprising squaring up an edge of the slide base that is opposite the edge of the material to be cut with the cutting blade of the cutting device.

13. The method of claim 12, further comprising executing the cut.

14. A method for assembling a cutting guide, comprising:
calibrating a custom measuring tape to account for a default distance from an edge of the cutting guide to a cutting blade of a cutting device to be positioned next to the edge of the cutting guide, wherein a distance between the cutting blade and the edge of the cutting guide varies between different cutting devices;
attaching the custom measuring tape to a tape measure mount;
attaching the tape measure mount to a slide base; and
attaching a measurement dial to the slide base, wherein the measurement dial is adjustable to account for a difference between the default distance and a particular distance between a particular cutting blade of a particular cutting device and the edge of the cutting guide.

15. The method of claim 14, wherein the measurement dial is arranged next to the tape measure mount, opposite the edge of the cutting device.

16. The method of claim 14, further comprising attaching a hand grip to the slide base.

17. The method of claim 14, wherein the slide base includes apertures to receive securing devices to secure the tape measure mount, the measurement dial, and the hand grip.

18. The method of claim 14, wherein the apertures allow the measurement tape mount, the measurement dial, and the hand grip to be secured to the slide base to accommodate right hand use or left-hand use.
